(19) United States
(12) Patent Application Publication
(10) Pub. No.: US 2020/0270151 A1
(43) Pub. Date: Aug. 27, 2020

(54) FILTER FOR REMOVING CHLORINE BY USING VITAMIN C

(71) Applicant: Ju Hyun KIM, Bucheon-si (KR)

(72) Inventor: Ju Hyun KIM, Bucheon-si (KR)

(21) Appl. No.: 16/646,123

(22) PCT Filed: Feb. 20, 2018
(86) PCT No.: PCT/KR2018/002040

§ 371 Date: Mar. 10, 2020

(30) Foreign Application Priority Data
Nov. 10, 2017 (KR) 10-2017-0149418

(51) Int. Cl. C02F 1/68; C02F 1/00

(52) U.S. Cl. CPC C02F 1/68; C02F 2101/12; C02F 1/003

(57) ABSTRACT

A filter is configured for chlorine using vitamin C, in which an impeller structure is formed on the upper part of the inside of a housing and the upper part of a cover so as to generate a whirling flow of raw water to uniformly mix vitamin C in the raw water. The filter is thereby capable of improving efficiency of removing chlorine components from the raw water. A space inside the housing is formed in a polygonal shape to fix a cylindrical capsule in the polygonal shape such that a plurality of vertical flow paths are formed by the space between the cylindrical capsule and the polygonal structure. Accordingly, the raw water flows at a uniform flow rate through the respective vertical flow paths, and the number of angles of the polygonal structure are formed according to a desired flow rate, thereby enabling the setting of flow rates.

### TECHNICAL FIELD

The present invention relates to a filter for removing chlorine by using vitamin C, and more particularly, to a filter for removing chlorine by using vitamin C, in which an impeller structure is formed on an inner upper end of a housing and an upper end of a cover so as to generate a whirling flow of raw water to uniformly mix the vitamin C in the raw water, so that efficiency of removing a chlorine component from the raw water can be improved, and in which an inner space of the housing is formed in a polygonal shape, and a cylindrical capsule is fixed to an inside of the polygonal shape, so that a plurality of vertical flow paths are defined by a space between the cylindrical capsule and the polygonal structure such that the raw water flows at a uniform flow rate through each of the vertical flow paths, and thus the flow rate can be set by determining the number of angles of the polygonal structure according to a desired flow rate.

### BACKGROUND ART

In general, water used as bathing water and face washing water is used at home after being pretreated in a water purification plant or the like. Tap water for use is sterilized by injecting a chlorine component in a water treatment facility, and a small amount of chlorine remains in such sterilized raw water to perform a function of preventing harmful bacteria in a water pipe or an inflow stage even in a process of supplying the sterilized raw water to homes or industrial sites. However, the residual chlorine dissolved in the raw water may cause a peculiar smell of the tap water, which disgusts a user, may react with sensitive skin to cause various skin problems, and may cause the generation of carcinogens such as trihalomethane.

As described above, although the chlorine remaining in the tap water is necessary for the sterilization of the raw water, the residual chlorine is harmful to a human body as a result, so that it is preferable to completely remove the residual chlorine for use.

Accordingly, various water treatment filters are mounted and used in water treatment products such as a water softener, a shower, a bidet, a faucet for tap water, a faucet for a sink, a toilet, a washing machine, a humidifier, a body shower, a one-pool-type bathtub, and a bathtub having a spa function.

However, such a conventional water treatment filter has a disadvantage in that residual chlorine removal efficiency is relatively low, and a service life is very short.

Meanwhile, the related art about a chlorine removal filter is disclosed in Korean Utility Model Registration No. 20-0178759 and the like.

### DETAILED DESCRIPTION OF THE INVENTION

### Technical Problem

In order to solve the above problems, an object of the present invention is to provide a filter for removing chlorine by using vitamin C, in which an impeller structure is formed on an inner upper end of a housing and an upper end of a cover so as to generate a whirling flow of raw water to uniformly mix the vitamin C in the raw water, so that efficiency of removing a chlorine component from the raw water can be improved, and in which an inner space of the housing is formed in a polygonal shape, and a cylindrical capsule is fixed to an inside of the polygonal shape, so that a plurality of vertical flow paths are defined by a space between the cylindrical capsule and the polygonal structure such that the raw water flows at a uniform flow rate through each of the vertical flow paths, and thus the flow rate can be set by determining the number of angles of the polygonal structure according to a desired flow rate.

The objects to be accomplished by the present invention are not limited to the above object, and other objects that are not described above may be clearly understood by a person having ordinary skill in the art to which the invention pertains from the following description.

### Technical Solution

In order to achieve the above object, according to one embodiment of the present invention, there is provided a filter for removing chlorine by using vitamin C, the filter including: a housing having an inlet and a first impeller structure; a cylindrical capsule fixed in the housing and having a filling space filled with vitamin C; and a cover having an outlet and a protrusion, wherein upper and lower ends of the cylindrical capsule are fixed by the first impeller structure and the protrusion.

In this case, the first impeller structure formed in the housing may generate a whirling flow of raw water.

In addition, the filter for removing chlorine may further include a non-woven fabric fixed to an inner surface of the protrusion formed on the cover, wherein the non-woven fabric may filter out foreign substances and a lump of the vitamin C contained in raw water.

In addition, an inner surface of the housing may be configured to have a polygonal structure, and a plurality of vertical flow paths may be defined by a space between the polygonal structure and the capsule, such that raw water may flow at a uniform flow rate through each of the vertical flow paths.

Further, the cylindrical capsule may make close contact with an inside of the polygonal structure of the inner surface of the housing so as to be horizontally supported, and the flow rate of the raw water may be set by changing a number of angles of the polygonal structure.

Meanwhile, in order to achieve the above object, according to another embodiment of the present invention, there is provided a filter for removing chlorine by using vitamin C, the filter including: a housing having an inlet and an inner surface configured to have a polygonal structure; a cylindrical capsule fixed in the housing and having a filling space filled with vitamin C; and a cover having an outlet, a protrusion, and a second impeller structure, wherein a whirling flow of raw water is rotated by the second impeller structure formed on the cover.

### Advantageous Effects of the Invention

In the filter for removing chlorine by using vitamin C according to the present invention, the impeller structure is formed on the inner upper end of the housing and the upper end of the cover so as to generate primary and secondary whirling flows of the raw water to uniformly mix the vitamin C in the raw water, so that efficiency of removing the chlorine component from the raw water can be improved.

In addition, due to the whirling flow of the raw water, ejection of the raw water, which is mixed with the vitamin C, through the through-hole of the capsule can be accelerated.

In addition, since the inner space of the housing is formed in a polygonal shape, and the cylindrical capsule is fixed to the inside of the polygonal shape, a plurality of vertical flow paths are defined by the space formed between the cylindrical capsule and the polygonal structure such that the raw water flows at a uniform flow rate through each of the vertical flow paths, and thus the flow rate of the raw water flowing through each of the vertical flow paths is defined by determining the number of the angles of the polygonal structure according to the desired flow rate, so that the flow rate of the raw water discharged through the outlet can be set, finally.

In addition, since the raw water flows through each of the vertical flow paths at a uniform flow rate, the whirling flow is uniformly generated in the impeller structure formed in the cover to uniformly mix the vitamin C in the raw water, so that the efficiency of removing the chlorine component from the raw water can be further improved.

The effects of the present invention are not limited to the above effects, and other effects that are not described above may be clearly understood by those skilled in the art from the description of the claims.

### DESCRIPTION OF THE DRAWINGS

FIG. 1 is a perspective view showing a filter for removing chlorine by using vitamin C according to one embodiment of the present invention.

FIG. 2 is an exploded perspective view showing the filter for removing chlorine by using vitamin C according to one embodiment of the present invention.

FIG. 3 is a view showing an inside of a housing in the filter for removing chlorine by using vitamin C according to one embodiment of the present invention.

FIG. 4 is a view showing a whirling flow of raw water due to an impeller structure formed in the housing in the filter for removing chlorine by using vitamin C according to one embodiment of the present invention.

FIG. 5 is a view showing a state in which vitamin-C-dissolved raw water ejected from a through-hole by the whirling flow is uniformly mixed in the filter for removing chlorine by using vitamin C according to one embodiment of the present invention.

FIG. 6 is a perspective view showing a cover of the filter for removing chlorine by using vitamin C according to one embodiment of the present invention.

FIG. 7 is a sectional view taken along line A-A′ of FIG. 1.

FIG. 8 is a sectional view taken along line B-B′ of FIG. 1.

FIG. 9 is a view showing a state in which the filter for removing chlorine by using vitamin C is installed in a shower head according to one embodiment of the present invention.

### BEST MODE

The preferred embodiment of the present invention will be described in more detail with reference to the accompanying drawings, while the generally-known technical features will be omitted or briefly described for conciseness of description.

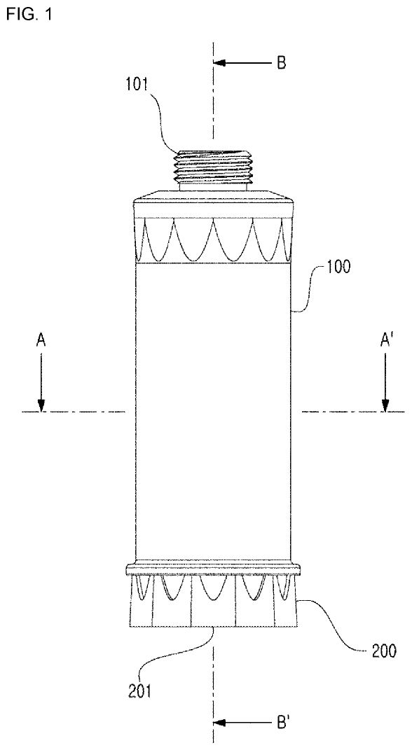

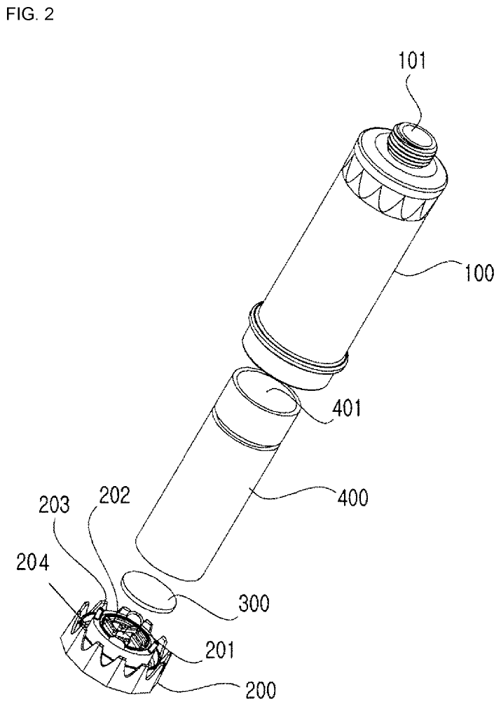

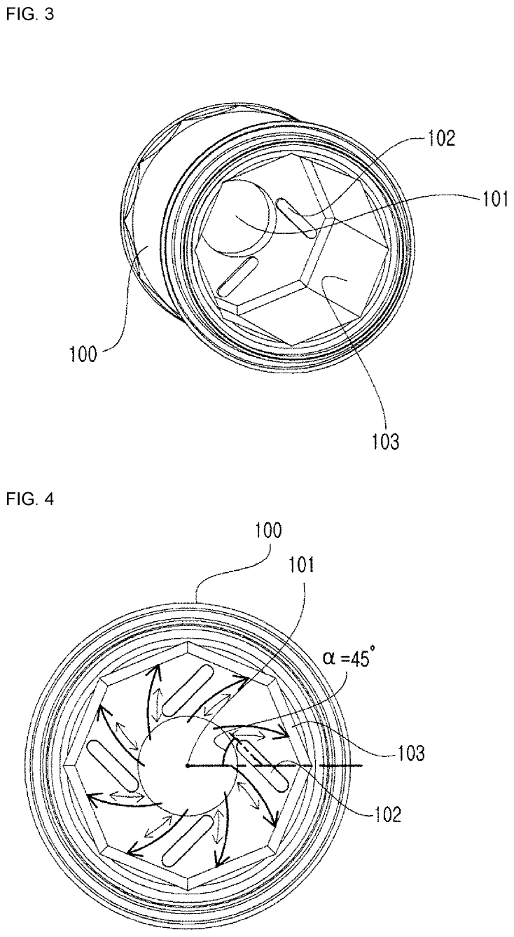

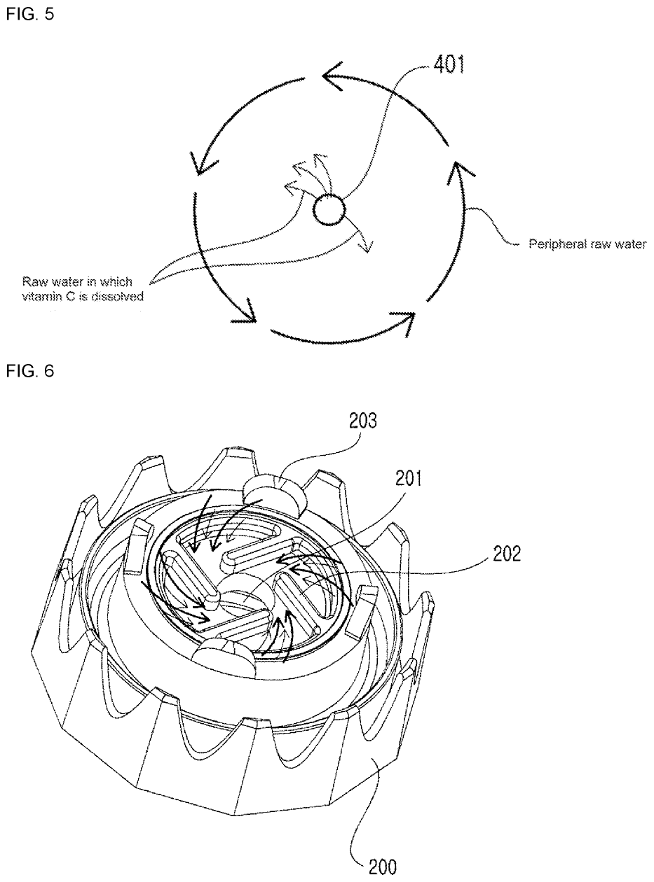

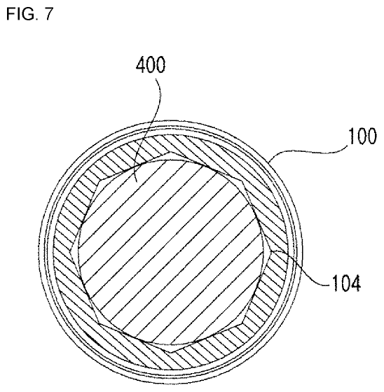

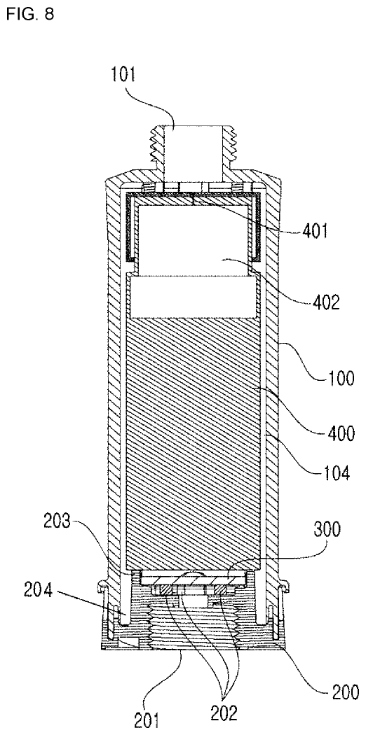

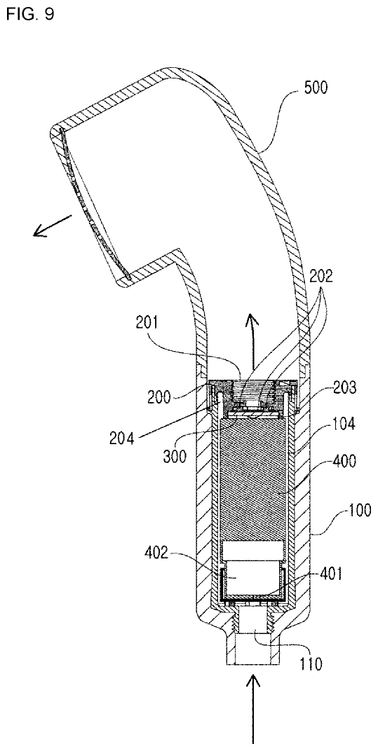

FIG. 1 is a perspective view showing a filter for removing chlorine by using vitamin C according to one embodiment of the present invention, FIG. 2 is an exploded perspective view showing the filter for removing chlorine by using vitamin C according to one embodiment of the present invention, FIG. 3 is a view showing an inside of a housing in the filter for removing chlorine by using vitamin C according to one embodiment of the present invention, FIG. 4 is a view showing a whirling flow of raw water due to an impeller structure formed in the housing in the filter for removing chlorine by using vitamin C according to one embodiment of the present invention, FIG. 5 is a view showing a state in which vitamin-C-dissolved raw water ejected from a through-hole by the whirling flow is uniformly mixed in the filter for removing chlorine by using vitamin C according to one embodiment of the present invention, FIG. 6 is a perspective view showing a cover of the filter for removing chlorine by using vitamin C according to one embodiment of the present invention, FIG. 7 is a sectional view taken along line A-A′ of FIG. 1, FIG. 8 is a sectional view taken along line B-B′ of FIG. 1, and FIG. 9 is a view showing a state in which the filter for removing chlorine by using vitamin C is installed in a shower head according to one embodiment of the present invention.

As shown in FIGS. 1 to 9, a filter for removing chlorine by using vitamin C according to one embodiment of the present invention may include a housing 100, a cover 200, a non-woven fabric 300, and a capsule 400.

The housing 100 may be formed at an upper end thereof with an inlet 101 which is a path through which raw water is introduced, and formed at an inner upper end thereof with a first impeller structure 102.

The first impeller structure 102 may serve to generate a whirling flow of the raw water together with a second impeller structure 202 formed in the cover 200, which will be described below. In addition, when the capsule 400 is coupled to an inside of the housing 100, the first impeller structure 102 may make contact with an upper end of the capsule 400, so that the capsule 400 may be spaced apart from the housing 100 by a height of the first impeller structure 102 so as to form a space, and a whirling flow of the raw water discharged through a through-hole 401 of the capsule 400 may be generated through the space due to the first impeller structure 102.

In this case, although the first impeller structure 102 has been shown in FIG. 4 as being configured such that an angle between a line which connects a center point of an inner diameter portion of the inlet 101 to a center point of the first impeller structure 102 and a line longitudinally extending from the center point of the first impeller structure 102 is 45 degrees, the angle may be appropriately selected in the range of 30 to 60 degrees according to a viscosity of a fluid.

In addition, a length of the first impeller structure 102 may be appropriately increased or decreased according to a size and an inner space of the filter.

In this case, the angle and the length of the first impeller structure 102 have to be selectively adjusted to the extent that the first impeller structure 102 does not interfere with the inner diameter portion of the inlet 101. In other words, the first impeller structure 102 may have an angle and a length appropriately selected to the extent that the first impeller structure 102 does not protrude inward of the inner diameter portion of the inlet 101.

A portion of the raw water may be introduced into the capsule 400 through the through-hole 401 by a pressure of the raw water at the upper end of the capsule 400 so as to dissolve a vitamin C gel, and the raw water in which the vitamin C is dissolved may be discharged to an outside through the through-hole 401 so as to move in a discharge direction of the housing 100 by the whirling flow of the raw water. In this case, a process of introducing and discharging the raw water through the through-hole 401 of the capsule 400 may be continuously performed.

The whirling flow of the raw water due to the first impeller structure 102 and the second impeller structure 202 will be described in detail below.

In addition, an inner surface of the housing 100 may have a polygonal structure 103 while an outer surface of the housing 100 has a cylindrical shape, the cylindrical capsule 400 which will be described below may be coupled to the inside of the housing 100 such that an outer surface of the capsule 400 fixedly makes contact with the polygonal structure 103, and a plurality of vertical flow paths 104 may be defined by a space formed between the cylindrical capsule 400 and the polygonal structure 103 as shown in FIG. 6, so that the raw water may flow at a uniform flow rate through each of the vertical flow paths 104.

Although the number of angles of the polygonal structure 103 has been shown in FIG. 7 as being eight, the number of the angles of the polygonal structure 103 is not limited thereto.

Accordingly, when the number of the angles of the polygonal structure 103 is predetermined according to a desired flow rate on the basis that the raw water flows at a uniform flow rate through each of the vertical flow paths 104, the flow rate of the raw water flowing through each of the vertical flow paths 104 may be defined, and finally, the flow rate of the raw water discharged through an outlet 201 may be set. In other words, the sum of sizes of the vertical flow paths 104 may be increased or decreased according to the number of the angles of the polygonal structure 103.

The cover 200 may be coupled to a lower end of the housing 100 in which the capsule 400 is coupled, and may include an outlet 201 through which the raw water mixed with the vitamin C to remove a chlorine component therefrom is discharged, a second impeller structure 202, a protrusion 203, and a circular groove 204.

As described above, the second impeller structure 202 may serve to generate the whirling flow of the raw water together with the first impeller structure 103 formed in the housing 100. Although the second impeller structure 202 has been shown in FIG. 6 as being formed at an angle of 45 degrees, similar to the first impeller structure 103, the angle and a length of the second impeller structure 202 may be variously adjusted to the extent that the second impeller structure 202 does not interfere with an inner diameter portion of the outlet 201.

A total of four protrusions 203 may be formed in a circumferential direction, and the non-woven fabric 300 may be fixedly fitted to inner surfaces of the protrusions 203.

In addition, when the cover 200 is coupled to the lower end of the housing after the capsule 400 is coupled to the inside of the housing 100, the protrusion 203 formed on the cover 200 may fixedly make contact with a lower end of the capsule, so that the lower end of the capsule 400 may be spaced apart from the cover 200 by a height of the protrusion 203 so as to form a space, and after the raw water flowing down to the vertical flow path 104 through the space is filled in the circular groove 204, the raw water reaches the second impeller structure 202 through a space between the protrusions 203 so that the whirling flow of the raw water may be generated.

As described above, the non-woven fabric 300 may be fixedly fitted to the inner surfaces of the protrusions 203, and may filter out foreign substances flowing in the raw water and vitamin C in the form of a lump smaller than the through-hole 401 by the non-woven fabric 300 having pores smaller than the through-hole 401 so as to prevent the foreign substances and the vitamin C from being discharged to the outlet 201.

The capsule 400 may have a cylindrical shape, and may have a through-hole 401 and a filling space 402.

The filling space 402 may be formed at an inner upper end of the capsule 400, and may be a space filled with vitamin C.

The raw water introduced through the inlet 101 may be introduced into the filling space 402 formed at the inner upper end of the capsule 400 through the through-hole 401 so as to be mixed with the vitamin C, and after the raw water mixed with the vitamin C is discharged through the through-hole 401 so that the whirling flow may be generated in the first impeller structure 102, the raw water may flow toward the cover 200 formed at the lower end of the capsule 400 through the vertical flow path 104.

Hereinafter, a moving path of the raw water and the generation of the whirling flow will be described in detail.

First, the raw water introduced through the inlet 101 of the housing 100 may flow into the filling space 402 formed in the capsule 400 through the through-hole 401 of the capsule 400 so as to be mixed with the vitamin C filled in the filling space 402, and the vitamin C may serve to remove the chlorine component remaining in the raw water.

As the raw water is continuously introduced into the filling space 402 formed in the capsule 400 through the inlet 101, the raw water mixed with the vitamin C may flow from the filling space 402 into the space formed by allowing the upper end of the capsule 400 to make contact with the first impeller structure 102 of the housing 100 through the through-hole 401, so that the whirling flow may be generated by the first impeller structure 102.

As shown in FIG. 4, the raw water flowing out through the through-hole 401 of the capsule 400 collides with the first impeller structure 102 to form the whirling flow. Accordingly, the whirling flow of the raw water may be uniformly divided into the vertical flow paths 104 divided by the polygonal structure 103 so as to move through the vertical flow paths 104.

In this case, as shown in FIG. 5, the raw water in which the vitamin C is dissolved, which has been discharged through the through-hole 401, may be uniformly dispersed and mixed in the raw water by a whirling flow of peripheral raw water.

As described above, since the whirling flow of the raw water mixed with the vitamin C in the filling space 402 is generated, the raw water and the vitamin C may be uniformly mixed with each other, so that efficiency of removing the chlorine component remaining in the raw water can be improved.

In addition, when the whirling flow is generated, a pressure at a center of the whirling flow may be decreased, so that a fluid around the center of the whirling flow may be sucked toward the center of the whirling flow. Therefore, the raw water in the filling space 402 may be sucked toward the center of the whirling flow through the through-hole 401, so that ejection of the raw water, which is mixed with the vitamin C in the filling space 402, through the through-hole 401 of the capsule 400 can be accelerated.

Thereafter, a primary whirling flow of the raw water generated by the first impeller structure 102 may flow to the circular groove 204, which is formed in the cover 200 coupled to the lower end of the housing 100, through the plurality of vertical flow paths 104 defined by the space between the cylindrical capsule 400 and the polygonal structure 103. In this case, the raw water may flow through each of the vertical flow paths 104 at a uniform flow rate. Accordingly, when the number of the angles of the polygonal structure 103 is predetermined according to a desired flow rate on the basis that the raw water flows at the uniform flow rate through each of the vertical flow paths 104, the flow rate of the raw water flowing through each of the vertical flow paths 104 may be defined, and finally, the flow rate of the raw water discharged through an outlet 201 may be set.

The raw water moved to the circular groove 204, which is formed in the cover 200 coupled to the lower end of the housing 100, through the vertical flow path 104 may flow to the second impeller structure 202 through the space between the protrusions 203 formed on the cover 200.

After the primary whirling flow of the raw water is generated by the first impeller structure 102, a secondary whirling flow of the raw water may be generated by the second impeller structure 202.

As shown in FIG. 6, the raw water moved through each of the vertical flow paths 104 may be uniformly mixed once more by the secondary whirling flow, so that the vitamin C can be mixed in the raw water more uniformly.

Accordingly, after the raw water is mixed with the vitamin C in the filling space 402, the whirling flows of the raw water are generated twice, so that the efficiency of removing the chlorine component remaining in the raw water can be remarkably improved.

The secondary whirling flow of the raw water generated by the second impeller structure 202 may be discharged through the outlet 201.

Meanwhile, FIG. 9 is a view showing a state in which the filter for removing chlorine by using vitamin C is installed in a shower head according to one embodiment of the present invention.

As shown in FIG. 9, the raw water flowing in through a shower hose (not shown) may pass through the inlet 110 and may be introduced into the filling space 402 through the through-hole 401 so as to be mixed with the vitamin C, and the raw water mixed with the vitamin C may move to the first impeller structure 102 through the through-hole 401.

Thereafter, as the raw water may be uniformly mixed with the vitamin C due to the primary whirling flow generated by the first impeller structure 102, the residual chlorine is removed, and the raw water may flow into the circular groove 204, which is formed in the cover 200, through the vertical flow path 104.

The raw water moved to the circular groove 204 may move to the second impeller structure 202 through the space between the protrusions 203 formed on the cover 200, and the secondary whirling flow may be generated by the second impeller structure 202.

The residual chlorine component may be removed by the primary and secondary whirling flows, and the raw water in which the vitamin C is uniformly mixed may be discharged through the outlet 201 of the cover 200 and discharged to the outside through a shower head 500.

Although the shower head has been illustrated in FIG. 9 as being a device to which the present invention is mounted, the present invention may be installed in a water tap (faucet). In addition, the present invention is not limited to the shower head or the water tap (faucet), and may be applied to any pipe through which a fluid flows.

As a result, in the filter for removing chlorine by using vitamin C according to the present invention, the impeller structure is formed on the inner upper end of the housing and the upper end of the cover so as to generate the primary and secondary whirling flows of the raw water to uniformly mix the vitamin C in the raw water, so that efficiency of removing the chlorine component from the raw water can be improved.

In addition, due to the whirling flow of the raw water, the ejection of the raw water, which is mixed with the vitamin C, through the through-hole of the capsule can be accelerated.

In addition, an inner space of the housing is formed in a polygonal shape, and the cylindrical capsule makes close contact with an inside of the polygonal shape so as to be supported by the inside of the polygonal shape, so that the cylindrical capsule can be horizontally supported without a separate support device provided in a horizontal direction. Further, the plurality of vertical flow paths are defined by the space formed between the cylindrical capsule and the polygonal structure, so that the polygonal structure can perform such a support function and simultaneously serve to form the vertical flow paths which are separated on an outer side of the capsule.

In addition, the flow rate of the raw water flowing through each of the vertical flow paths is defined by determining the number of the angles of the polygonal structure according to the desired flow rate, so that the flow rate of the raw water discharged through the outlet can be set, finally. Naturally, if the number of polygons of the polygonal structure is changed, an outer diameter of the capsule has to be formed accordingly so that an outer diameter portion of the capsule may make close contact with an inner surface of the polygonal structure.

Further, since the raw water flows through each of the vertical flow paths at the uniform flow rate, the whirling flow is uniformly generated in the impeller structure formed in the cover to uniformly mix the vitamin C in the raw water, so that the efficiency of removing the chlorine component from the raw water can be further improved.

In conclusion, after the raw water is primarily mixed with the vitamin C by the primary whirling flow generated by the first impeller structure, the raw water is uniformly distributed to the vertical flow paths by the primary whirling flow so that the raw water moves at a uniform flow rate through each of the vertical flow paths to the second impeller structure, and the secondary whirling flow is generated by the second impeller structure so that the raw water is secondarily mixed with the vitamin C. Therefore, the vitamin C can be mixed with the raw water very uniformly.

As described above, although the embodiment of the present invention has been described in detail with reference to the accompanying drawings, the above-described embodiment is merely a preferable example of the present invention, so that the present invention is not limited to the above-described embodiment, and it is to be understood that the scope of the present invention is defined by the following claims and equivalent concepts thereof.

1. A filter for removing chlorine by using vitamin C, the filter comprising:
a housing having an inlet and a first impeller structure;
a cylindrical capsule fixed to an inside of the housing and having a filling space filled with vitamin C; and
a cover having an outlet and a protrusion,
wherein upper and lower ends of the cylindrical capsule are fixed by the first impeller structure and the protrusion.

2. The filter of claim 1, wherein the first impeller structure formed in the housing generates a whirling flow of raw water.

3. The filter of claim 1, further comprising a non-woven fabric fixed to an inner surface of the protrusion formed on the cover,
wherein the non-woven fabric filters out foreign substances and a lump of the vitamin C contained in raw water.

4. The filter of claim 1, wherein an inner surface of the housing is configured to have a polygonal structure, and a plurality of vertical flow paths are defined by a space between the polygonal structure and the capsule, such that raw water flows at a uniform flow rate through each of the vertical flow paths.

5. The filter of claim 4, wherein the cylindrical capsule makes close contact with an inside of the polygonal structure of the inner surface of the housing so as to be horizontally supported, and
the flow rate of the raw water is set by changing a number of angles of the polygonal structure.

6. A filter for removing chlorine by using vitamin C, the filter comprising:
a housing having an inlet and an inner surface configured to have a polygonal structure;
a cylindrical capsule fixed to an inside of the housing and having a filling space filled with vitamin C; and
a cover having an outlet, a protrusion, and a second impeller structure,
wherein a whirling flow of raw water is rotated by the second impeller structure formed on the cover.
